(19) United States
(12) Patent Application Publication
(10) Pub. No.: US 2018/0109856 A1
(43) Pub. Date: Apr. 19, 2018

(54) MANAGEMENT DEVICE AND WAVELENGTH SETTING METHOD

(71) Applicant: Fujitsu Limited, Kawasaki-shi (JP)

(72) Inventor: Toshiki HONDA, Kawasaki (JP)

(73) Assignee: Fujitsu Limited, Kawasaki-shi (JP)

(21) Appl. No.: 15/720,422

(22) Filed: Sep. 29, 2017

(30) Foreign Application Priority Data
Oct. 13, 2016 (JP) 2016-201479

(51) Int. Cl. H04Q 11/00; H04J 14/02

(52) U.S. Cl. CPC H04Q 11/0005; H04J 14/0221; H04Q 2011/0037; H04Q 2011/0052; H04J 14/0212

(57) ABSTRACT

There is provided a management device configured to manage a plurality of optical nodes in an optical transmission system, the management device including a memory, and a processor coupled to the memory and the processor configured to specify an optical node to terminate a traffic in the optical transmission system, determine whether or not a first optical component that does not use a wavelength being used in a second optical component included in the specified optical node exists in the specified optical node, determine whether or not a path that makes the wavelength usable exists in the optical transmission system when it is determined that the first optical component exists in the specified optical node, and set the wavelength and the path that makes the wavelength usable in the first optical component when it is determined that the path making the wavelength usable exists in the specified optical node.

### CROSS-REFERENCE TO RELATED APPLICATION

This application is based upon and claims the benefit of priority of the prior Japanese Patent Application No. 2016-201479, filed on Oct. 13, 2016, the entire contents of which are incorporated herein by reference.

### FIELD

The embodiments discussed herein are related to a management device and a wavelength setting method.

### BACKGROUND

In recent years, a WDM transmission system using wavelength division multiplexing (WDM) that, for example, multiplexes and transmits optical signals having different wavelengths has been distributed. In the WDM transmission system, a plurality of ROADMs (Reconfigurable Optical Add Drop Multiplexer) is connected by optical fibers. ROADM is an optical add drop multiplexer (OADM) that can branch an optical signal having a desired wavelength from a WDM signal and insert an optical signal into an empty channel of the WDM signal.

Since an optical path is fixed for each wavelength, ROADM may not perform wavelength change or path change by remote operation. Therefore, workers have to be dispatched to office buildings to work for wavelength change and path change, imposing a big burden on the workers. Therefore, for example, CD (Colorless Directionless)-ROADM, CDC (Colorless Directionless Contention less)-ROADM and the like have appeared as the next generation ROADM which enables wavelength change and path change by remote operation. “Colorless” means that a wavelength may be changed without changing the connection with an optical fiber from a remote place. “Directionless” means that a direction may be changed without changing the connection with an optical fiber from a remote place. Further, “Contention less” means to avoid wavelength contention.

In a CD-ROADM including optical components such as optical couplers and optical splitters, optical signals having the same wavelength may not pass through the same optical coupler and optical splitter due to the properties of the optical components, causing a contention where wavelengths collide with each other. Consequently, an avoidance of contention acts as a restriction on optical line design of an optical transmission system formed with a plurality of CD-ROADMs.

Related technologies are disclosed in, for example, Japanese Laid-Open Patent Publication Nos. 2012-060622, 2014-022865, and 2014-107709.

### SUMMARY

According to an aspect of the invention, a management device is configured to manage a plurality of optical nodes in an optical transmission system, the management device includes a memory, and a processor coupled to the memory and the processor configured to specify an optical node to terminate a traffic in the optical transmission system, determine whether or not a first optical component that does not use a wavelength being used in a second optical component included in the specified optical node exists in the specified optical node, determine whether or not a path that makes the wavelength usable exists in the optical transmission system when it is determined that the first optical component exists in the specified optical node, and set the wavelength and the path that makes the wavelength usable in the first optical component when it is determined that the path making the wavelength usable exists in the specified optical node.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view illustrating an example of an optical transmission system according to a first embodiment;

FIG. 2 is an explanatory view illustrating an exemplary hardware configuration of CD-ROADM;

FIG. 3 is an explanatory view illustrating an exemplary functional configuration of an SDN controller according to the first embodiment;

FIG. 4 is an explanatory view illustrating an example of processing related to a first determination process;

FIG. 5 is an explanatory view illustrating an example of processing related to a second determination process;

FIG. 6 is a flowchart illustrating an example of a processing operation of CPU related to a setting process;

FIG. 7 is a flowchart illustrating an example of a processing operation of an extraction unit related to an extraction process;

FIG. 8 is a flowchart illustrating an example of a processing operation of a first determination unit related to the first determination process;

FIG. 9 is a flowchart illustrating an example of a processing operation of a second determination unit related to the second determination process;

FIG. 10 is an explanatory view illustrating an exemplary functional configuration of an SDN controller according to a second embodiment;

FIG. 11 is a flowchart illustrating an example of a processing operation of a third determination unit related to a third determination process;

FIG. 12 is a flowchart illustrating an example of a processing operation of a fourth determination unit related to a fourth determination process;

FIG. 13A is an explanatory view illustrating an example of a wavelength allocation method of an optical transmission system according to another embodiment; and

FIG. 13B is an explanatory view illustrating an example of a wavelength allocation method of an optical transmission system according to still another embodiment.

### DESCRIPTION OF EMBODIMENTS

In an optical transmission system having a plurality of CD-ROADMs, for example, contention may be avoided by sequentially allocating empty wavelengths for each traffic in the order of occurrence of traffic. However, in the optical transmission system, when empty wavelengths are sequentially allocated in the order of occurrence of traffic, although contention may be avoided, wavelength fragmentation occurs, which lowers the utilization efficiency of wavelength resources. Moreover, in a complicated optical transmission system such as a mesh configuration, the wavelength fragmentation partially occurs and the number of wavelengths to be allocated to signals transmitted over a plurality of spans becomes extremely small, which remarkably lowers the utilization efficiency of wavelength resources.

Embodiments of a technique capable of improvement of the utilization efficiency of wavelength resources will be described in detail below with reference to the drawings. Incidentally, the disclosed technology is not limited by these embodiments. In addition, the following embodiments may be used in proper combination unless contradictory.

### First Embodiment

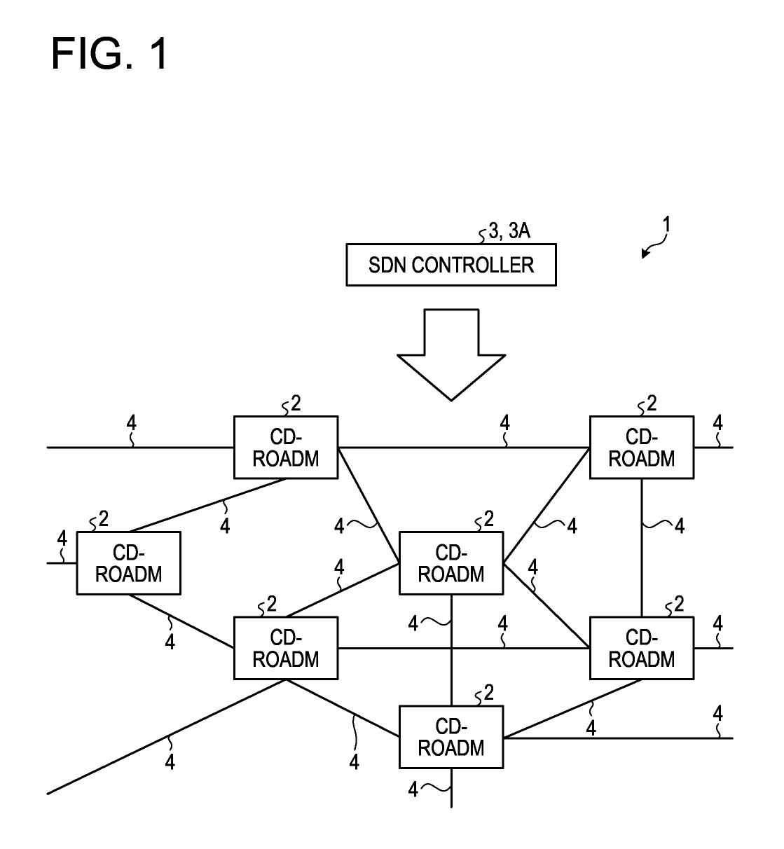

FIG. 1 is an explanatory view illustrating an example of an optical transmission system 1 according to a first embodiment. As illustrated in FIG. 1, the optical transmission system 1 includes a plurality of CD-ROADMs 2 and a software defined network (SDN) controller 3. Each CD-ROADM 2 is an optical add/drop device such as a wavelength division multiplex (WDM) transmission device that multiplexes and transmits a plurality of optical signals having different wavelengths. The CD-ROADM 2 is an optical add/drop device which is connected to another CD-ROADM 2 through an optical fiber 4 and optically inserts (adds) and branches (drops) optical signals having different wavelengths. The SDN controller 3 monitors and controls the entire optical transmission system 1. For example, the optical transmission system 1 has a mesh configuration in which the plurality of CD-ROADMs 2 are connected to each other in a mesh form by optical fibers 4.

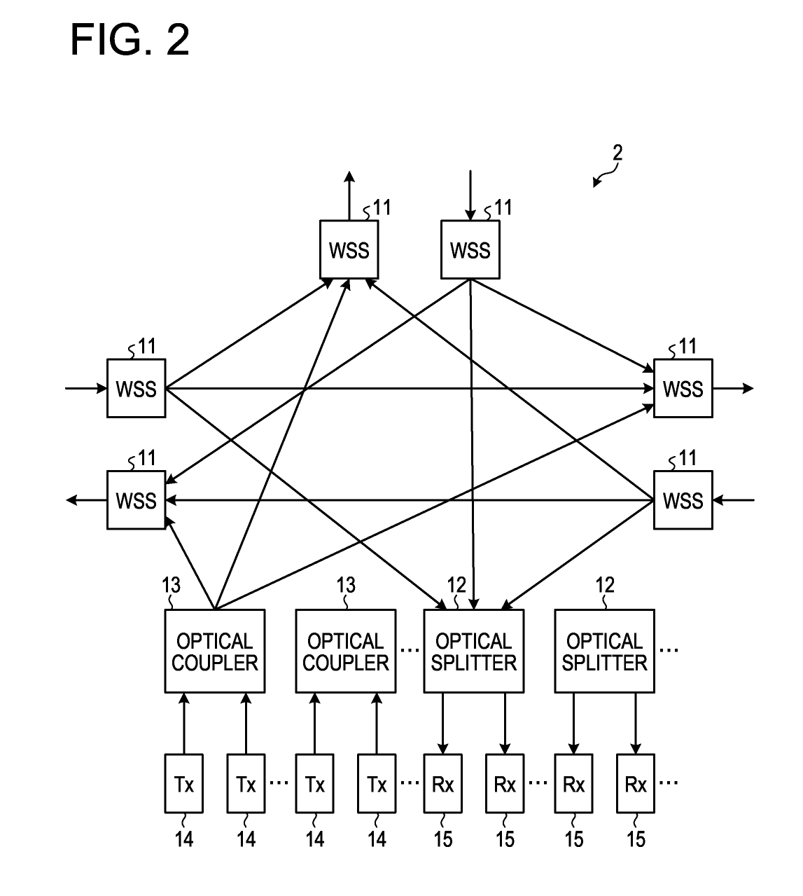

FIG. 2 is an explanatory view illustrating an exemplary hardware configuration of the CD-ROADM 2. As illustrated in FIG. 2, the CD-ROADM 2 includes a plurality of wavelength selective switches (WSSs) 11, a plurality of optical splitters 12, a plurality of optical couplers 13, a plurality of transmitters (Txs) 14, and a plurality of receivers (Rxs) 15. The transmitters 14 and the receivers 15 are, for example, line cards. A WSS 11 is a switch for switching and selecting an optical signal on a wavelength basis. The WSS 11 has, for example, input ports having the number that is equal to one input portxN output ports. An optical coupler 13 is an optical insertion unit that optically inserts an optical signal on a wavelength basis. An optical splitter 12 is an optical branching unit that optically branches an optical signal on a wavelength basis. A transmitter 14 is a line card that transmits an optical signal. A receiver 15 is a line card that receives an optical signal.

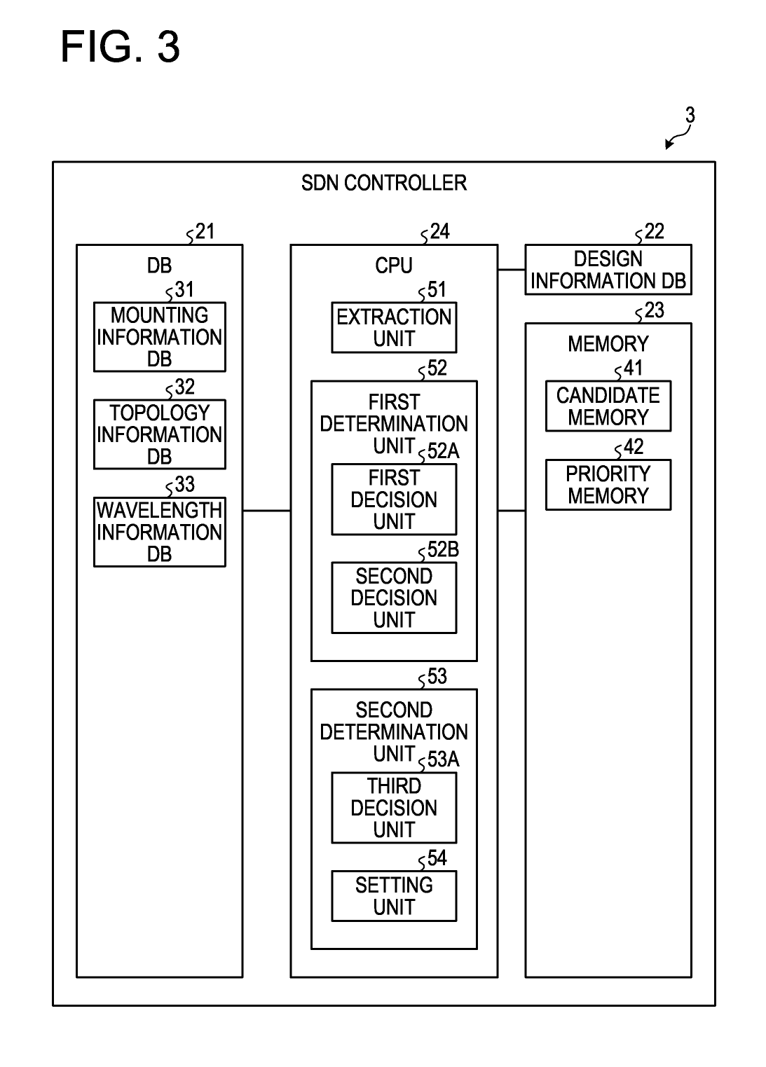

FIG. 3 is an explanatory view illustrating an exemplary functional configuration of the SDN controller 3 according to the first embodiment. As illustrated in FIG. 3, the SDN controller 3 includes a database (DB) 21, a design information DB 22, a memory 23, and a CPU 24. The DB 21 includes a mounting information DB 31, a topology information DB 32, and a wavelength information DB 33. The mounting information DB 31 is a DB for managing mounting information of optical components such as the WSSs 11, the optical splitters 12, the optical couplers 13, the transmitters 14, and the receivers 15 in the CD-ROADM 2. The mounting information is a variety of specification information such as the number of ports and an allowable wavelength of an optical component. The topology information DB 32 is a DB that manages connection information such as a path configuration that is the connection status of each WSS 11, optical splitter 12, optical coupler 13, transmitter 14, and receiver 15. The wavelength information DB 33 is a DB that manages the wavelength use situation of each WSS 11, optical splitter 12, optical coupler 13, transmitter 14, receiver 15, and path. The design information DB 22 is a DB that manages the design contents of the optical transmission system 1, for example, the transmission propriety for each path.

The memory 23 is an area that stores various kinds of information. The memory 23 includes a candidate memory 41 and a priority memory 42. The candidate memory 41 is an area that stores candidate paths and candidate wavelengths to be described later. The priority memory 42 is an area that stores candidate paths according to a priority to be described later.

The CPU 24 includes an extraction unit 51, a first determination unit 52, a second determination unit 53, and a setting unit 54. The extraction unit 51 refers to the design information DB 22 to extract candidate paths for each traffic according to the selection criteria, and prioritizes and stores the extracted candidate paths in the priority memory 42. It is assumed that the priority memory 42 stores top five candidate paths.

By executing a first determination process to be described later, the first determination unit 52 determines a wavelength to be allocated for each traffic and a path to be allocated for each traffic. The first determination unit 52 includes a first decision unit 52A and a second decision unit 52B. The first decision unit 52A specifies a CD-ROADM 2 that is the start point (termination) of a new traffic generated in the optical transmission system 1. Further, the first decision unit 52A decides whether or not another optical coupler 13, which does not use a wavelength being used by an optical coupler 13 in the specified CD-ROADM 2, exists in the CD-ROADM 2. When it is decided in the first decision unit 52A that another optical coupler 13, which does not use the wavelength being used by the optical coupler 13, exists in the CD-ROADM 2, the second decision unit 52B decides whether or not there is a path which makes the wavelength usable. By executing a second determination process to be described later, the second determination unit 53 determines a wavelength to be allocated for each traffic and a path to be allocated for each traffic. The second determination unit 53 includes a third decision unit 32A. When it is decided in the first decision unit 52A that another optical coupler 13, which does not use the wavelength being used by the optical coupler 13, does not exist in the CD-ROADM 2, the third decision unit 53A specifies an adjacent wavelength adjacent to the wavelength being used by the optical coupler 13. The third decision unit 53A decides whether or not there is a path which makes the specified adjacent wavelength usable. The setting unit 54 sets the allocated wavelength and allocated path for each traffic in the WSS 11, the optical splitter 12, the optical coupler 13, the transmitter 14, and the receiver 15 in the target CD-ROADM 2. For example, the setting unit 54 sets the allocated wavelength for each traffic in the transmitter 14 and the receiver 15 and sets the allocated path for each traffic in the WSS 11.

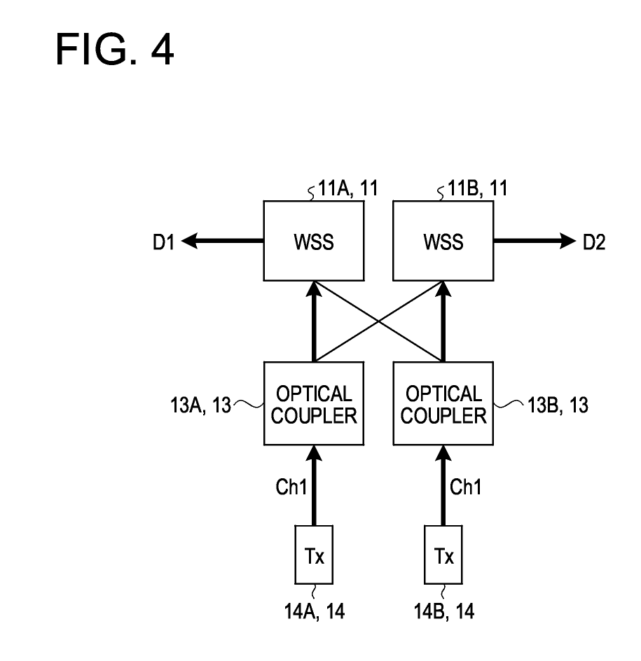

FIG. 4 is an explanatory view illustrating an example of processing related to the first determination process. In the example of FIG. 4, it is assumed that a transmitter 14A serves as a start point and a new traffic is generated while arranging an optical path of a wavelength Ch1 in a direction D1 via an optical coupler 13A and a WSS 11A. It is also assumed that the wavelength Ch1 is the shortest wavelength. The first decision unit 52A in the first determination unit 52 specifies a CD-ROADM 2 serving as the start point of the new traffic. The first decision unit 52A decides whether or not there is the shortest wavelength that may be used by the CD-ROADM 2 serving as the start point of the new traffic. In the example of FIG. 4, the shortest wavelength is the wavelength Ch1. When there is the shortest wavelength, the first decision unit 52A decides the wavelength Ch1, which is the shortest wavelength, as a candidate wavelength to be allocated. The second decision unit 52B in the first determination unit 52 decides whether or not an available optical coupler 13 whose candidate wavelength is unused exists in the CD-ROADM 2. In the example of FIG. 4, an unused optical coupler 13 is an optical coupler 13B. The second decision unit 52B decides whether or not there is a candidate path that may use the candidate wavelength. In the example of FIG. 4, it is determined that the wavelength Ch1 is a direction D2 of a usable optical coupler 13B as a candidate path that can use the candidate wavelength. As a result, an optical path of a new traffic is arranged in the direction D2 via the optical coupler 13B and the WSS 11B with a transmitter 14B serving as a start point.

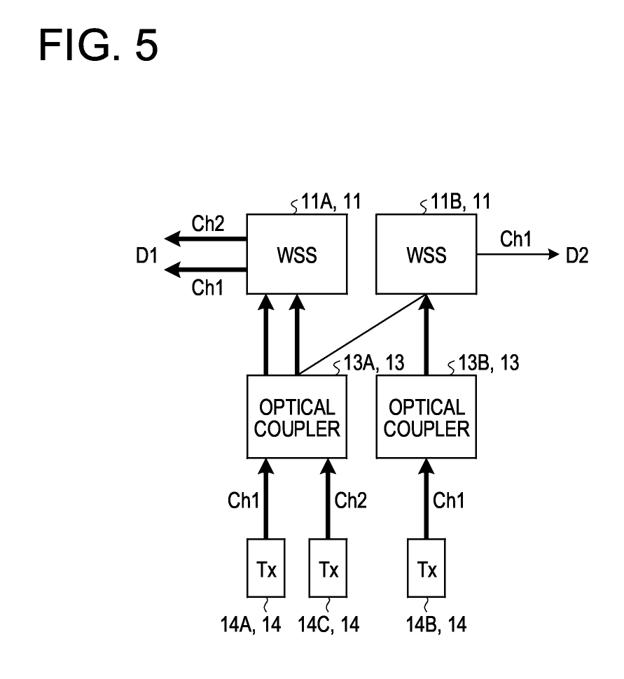

FIG. 5 is an explanatory view illustrating an example of processing related to the second determination process. In the example of FIG. 5, the optical path of the wavelength Ch1 is arranged in the direction D1 via the optical coupler 13A and the WSS 11A with a transmitter 14A serving as a start point, and the optical path of the wavelength Ch1 is arranged in the direction D2 via the optical coupler 13B and the WSS 11B with a transmitter 14B serving as a start point. It is assumed that a new traffic is generated under this situation. However, since the wavelength Ch1 is being used by the optical couplers 13A and 13B, the first determination unit 52 may not allocate the shortest wavelength Ch1 to the optical couplers 13A and 13B. Therefore, the third decision unit 53A in the second determination unit 53 decides whether or not there is the highest-level candidate path in the priority memory 42. In the example of FIG. 5, the highest-level candidate path is the direction D1. When there is the highest-level candidate path, the third decision unit 53A decides whether or not there is an adjacent usable unused candidate wavelength out of the shortest wavelengths being used on the candidate path. In the example of FIG. 5, since the shortest wavelength being used on the path D1 is the wavelength Ch1, an unused candidate wavelength is the next shortest wavelength Ch2 adjacent to the shortest wavelength Ch1. The third decision unit 53A decides whether or not an optical coupler 13 making the unused candidate wavelength usable exists in the CD-ROADM 2. In the example of FIG. 5, the optical coupler 13 making the unused candidate wavelength Ch2 usable is the optical coupler 13A. As a result, in the example of FIG. 5, using the candidate wavelength Ch2, the optical path of a new traffic is arranged in the direction D1 via the optical coupler 13A and the WSS 11A with a transmitter 14C serving as a start point.

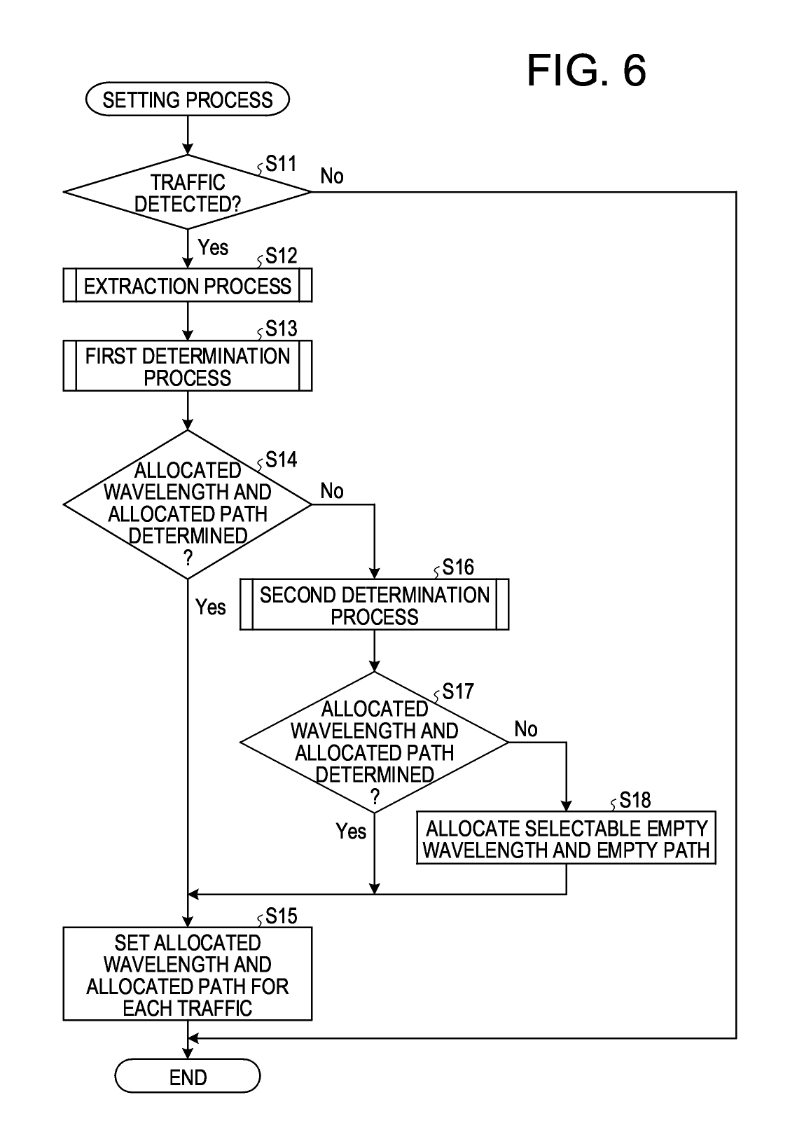

FIG. 6 is a flowchart illustrating an example of a processing operation of the CPU 24 related to the setting process. In FIG. 6, the CPU 24 determines whether or not a traffic is detected (Operation S11). When it is determined that a traffic is detected (“Yes” in Operation S11), the CPU 24 executes the extraction process (Operation S12). After executing the extraction process, the CPU 24 executes the first determination process of determining the allocated wavelength and the allocated path in the first determination unit 52 (Operation S13). After executing the first determination process, the CPU 24 determines whether or not the allocated wavelength and the allocated path have been determined in the first determination process (Operation S14).

When it is determined that the allocated wavelength and the allocated path have been determined in the first determination process (“Yes” in Operation S14), the CPU 24 sets the allocated path and the allocated wavelength for each traffic in a CD-ROADM 2 on the allocated path (Operation S15) and ends the processing operation illustrated in FIG. 6. When it is determined that the allocated wavelength and the allocated path have not been determined in the first determination process (“No” in Operation S14), the CPU 24 determines that there is no solution and executes the second determination process of determining the allocated wavelength and the allocated path in the second determination unit 53 (Operation S16). After executing the second determination process, the CPU 24 determines whether or not the allocated wavelength and the allocated path have been determined in the second determination process (Operation S17).

When it is determined that the allocated wavelength and the allocated path have been determined in the second determination process (“Yes” in Operation S17), the CPU 24 proceeds to Operation S15 where the allocated wavelength and the allocated path are set in each target CD-ROADM 2. When the allocated wavelength and the allocated path have not been determined in the second determination process (NO in Operation S17), the CPU 24 determines that there is no solution, and determines a selectable empty wavelength as the allocated wavelength and a selectable empty path as the allocated path (Operation S18). Then, the CPU 24 proceeds to Operation S15 where the allocated wavelength and the allocated path are set in each target CD-ROADM 2. When it is determined that no traffic has been detected (“No” in Operation S11), the CPU 24 ends the processing operation illustrated in FIG. 6.

When determining the allocated wavelength and the allocated path in the first determination process or the second determination process, the CPU 24 executing the setting process illustrated in FIG. 6 sets the allocated path and the allocated wavelength in the target CD-ROADM 2. As a result, it is possible to arrange the optimal optical path for a new traffic.

When the allocated wavelength and the allocated path may not be determined in the first determination process and the second determination process, the CPU 24 sets a selectable empty wavelength and a selectable empty path as the allocated wavelength and the allocated path, respectively. As a result, it is possible to arrange an optical path for a new traffic.

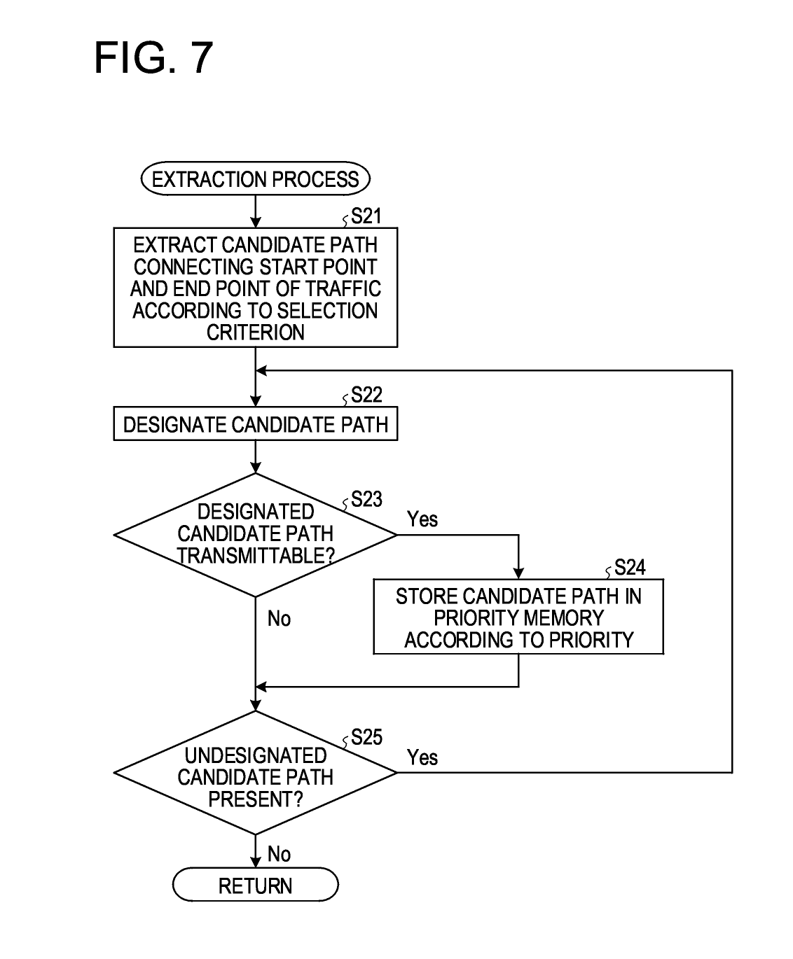

FIG. 7 is a flowchart illustrating an example of a processing operation of the extraction unit 51 related to the extraction process. In FIG. 7, the extraction unit 51 refers to the design information DB 22 to extract a candidate path connecting the start point and the end point of a traffic according to a selection criterion (Operation S21). The selection criterion is, for example, the descending order of transmission distance but may be the descending order of the number of relay nodes or the descending order of the number of spans.

After extracting the candidate path, the extraction unit 51 designates the candidate path (Operation S22) and refers to the design information DB 22 to determine whether or not the designated candidate path may be transmitted (Operation S23). When it is determined that the designated candidate path may be transmitted (“Yes” in Operation S23), the extraction unit 51 stores the candidate path in the priority memory 42 according to a priority (Operation S24). The priority is, for example, the descending order of transmission distance. For example, the extraction unit 51 increases the priority for a candidate path having the shortest transmission distance and decreases the priority for a candidate path having the longest transmission distance.

After storing the candidate path in the priority memory 42, the extraction unit 51 determines whether or not there is an undesignated candidate path in the priority memory 42 (Operation S25). When it is determined that there is an undesignated candidate path (“Yes” in Operation S25), the extraction unit 51 proceeds to Operation S22 where the candidate path is designated. When it is determined that the designated candidate path may not be transmitted (“No” in Operation S23), the extraction unit 51 proceeds to Operation S25 where it is determined whether or not there is an undesignated candidate path. When it is determined that there is no undesignated candidate path in the priority memory 42 (“No” in Operation S25), the extraction unit 51 ends the processing operation illustrated in FIG. 7.

The extraction unit 51 executing the extraction process illustrated in FIG. 7 refers to the design information DB 22 to extract the candidate path connecting the start point and the end point of a traffic according to the setting criterion and stores a candidate path, which can transmit traffic, in the priority memory 42 according to a priority. As a result, it is possible to manage candidate paths which can transmit traffics with priorities given to the traffics.

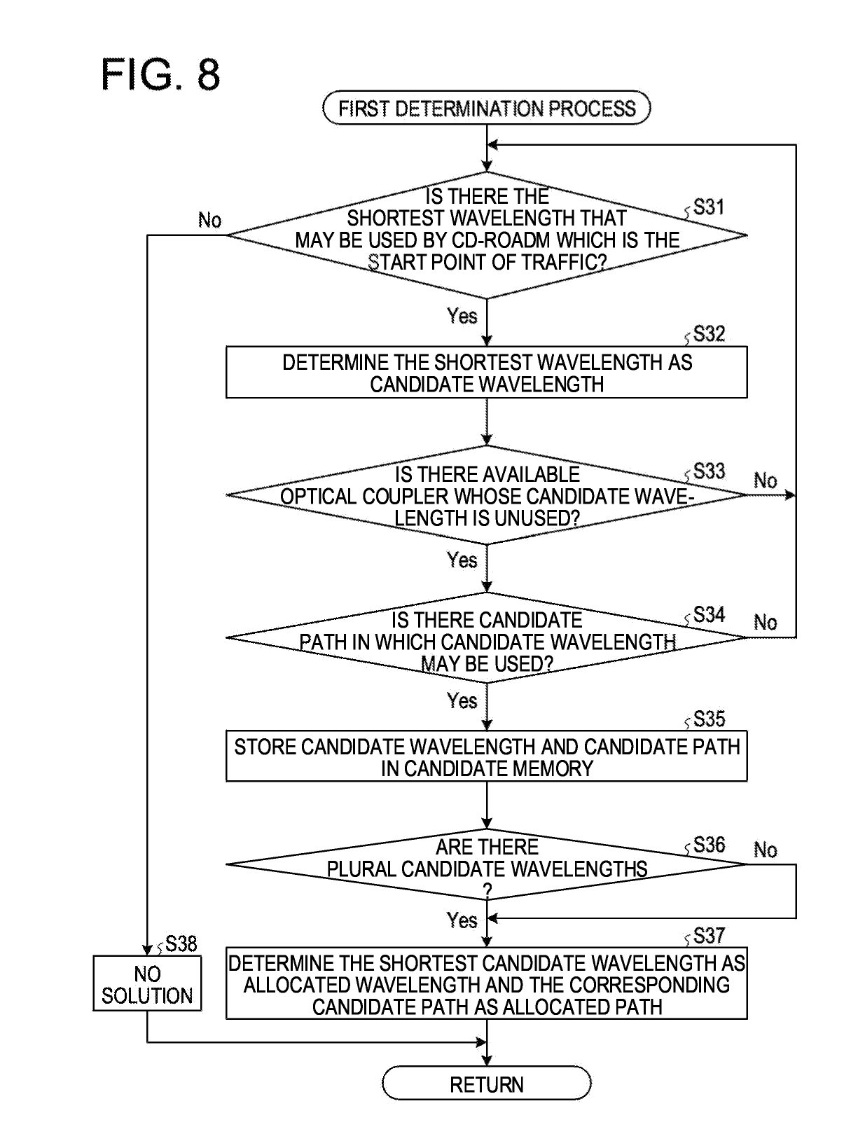

FIG. 8 is a flowchart illustrating an example of the processing operation of the first determination unit 52 related to the first determination process. In FIG. 8, the first determination unit 52 refers to the mounting information DB 31, the wavelength information DB 33 and the topology information DB 32 to determine whether or not there is the shortest wavelength that may be used by a CD-ROADM 2 which is the start point of traffic (Operation S31).

When it is determined that there is an unused shortest wavelength of a path that may be used in a node serving as the start point of traffic (“Yes” in Operation S31), the first determination unit 52 sets the shortest wavelength as a candidate wavelength (Operation S32). The first determination unit 52 refers to the wavelength information DB 33 and the mounting information DB 31 to determine whether or not an available optical coupler 13 whose candidate wavelength is unused exists in the CD-ROADM 2 (Operation S33). Incidentally, the CD-ROADM 2 is a CD-ROADM 2 serving as a start point of traffic.

When it is determined that the available optical coupler 13 whose candidate wavelength is unused exists in the CD-ROADM 2 (“Yes” in Operation S33), the first determination unit 52 determines whether or not there is a candidate path in which the candidate wavelength may be used (Operation S34). When it is determined that there is a candidate path in which the candidate wavelength may be used (“Yes” in Operation S34), the first determination unit 52 stores the candidate wavelength and the candidate path in the candidate memory 41 (Operation S35).

The first determination unit 52 determines whether or not there is a plurality of candidate wavelengths in the candidate memory 41 (Operation S36). When it is determined that there is a plurality of candidate wavelengths in the candidate memory 41 (“Yes” in Operation S36), the first determination unit 52 determines a shortest candidate wavelength among the plurality of candidate wavelengths as an allocated wavelength and a candidate path corresponding to the shortest candidate wavelength as an allocated route (Operation S37). When it is determined that there is not a plurality of candidate wavelengths in the candidate memory 41 (“No” in Operation S36), the first determination unit 52 proceeds to Operation S37 to determine the shortest candidate wavelength as an allocated wavelength and a candidate path corresponding to the shortest candidate wavelength as an allocated route.

When it is determined that there is no shortest wavelength that may be used by the CD-ROADM 2 which is the start point of the traffic (“No” in Operation S31), the first determination unit 52 determines that there is no solution of the first determination process (Operation S38), and ends the processing operation illustrated in FIG. 8. When it is determined that no available optical coupler 13 whose candidate wavelength is unused exists in the CD-ROADM 2 (“No” in Operation S33), the first determination unit 52 proceeds to Operation S31. When it is determined that there is no candidate path in which the candidate wavelength may be used (“No” in Operation S34), the first determination unit 52 proceeds to Operation S31.

In the first determination unit 52 executing the first determination process illustrated in FIG. 8, when there is the shortest wavelength that may be used in the CD-ROADM 2 serving as the start point of traffic, the shortest wavelength is set as the candidate wavelength, and it is determined whether or not an optical coupler 13 that can use the candidate wavelength exists in the CD-ROADM 2. When an optical coupler 13 that can use the candidate wavelength exists in the CD-ROADM 2, the first determination unit 52 determines whether or not there is a candidate path in which the candidate wavelength may be used. When there is a candidate path in which the candidate wavelength may be used, the first determination unit 52 stores the candidate wavelength and the candidate path in the candidate memory 41. The first determination unit 52 determines the shortest candidate wavelength in the candidate memory 41 as an allocated wavelength and the candidate path corresponding to the shortest candidate wavelength as an allocated path. As a result, the first determination unit 52 can determine the optimal allocated wavelength and allocated path to be used for a new traffic by remote operation. Furthermore, the first determination unit 52 can reduce the number of wavelengths to be contended, reduce the chance of irregular wavelength arrangement due to contention avoidance, and suppress wavelength fragmentation, which can result in improvement of the utilization efficiency of wavelength resources.

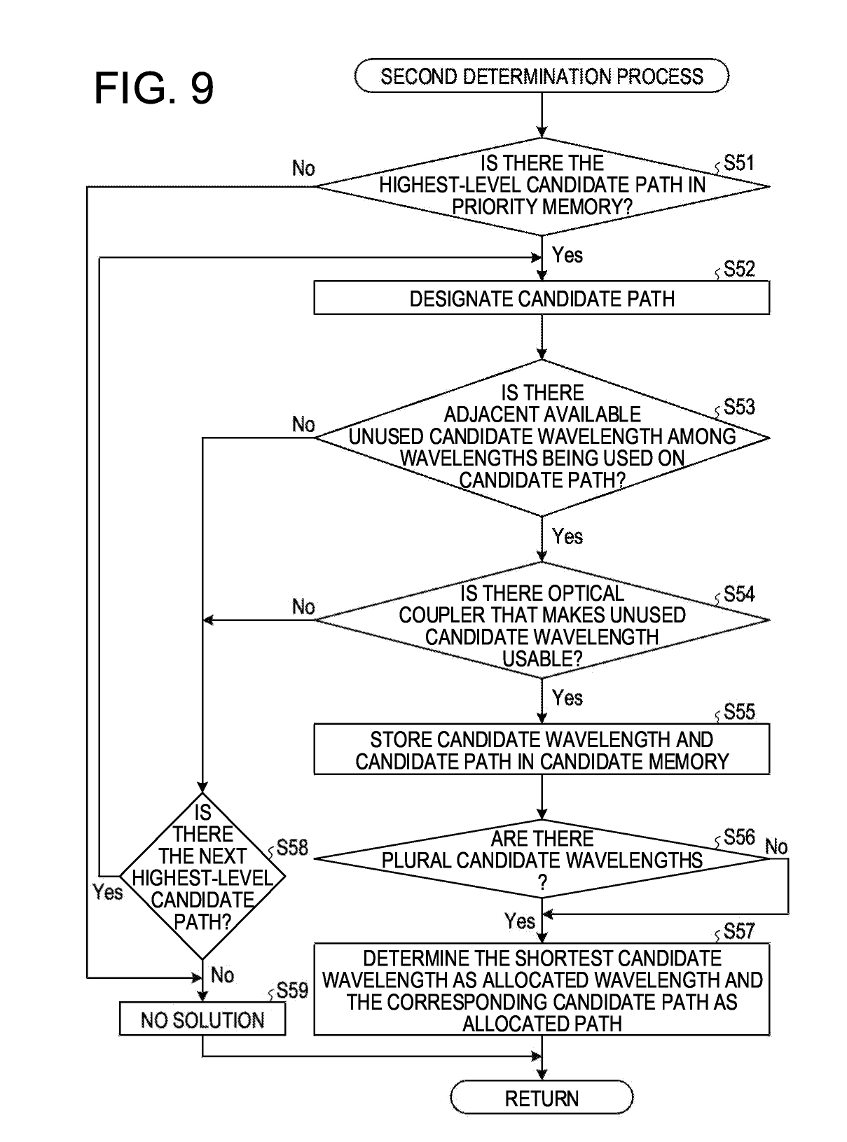

FIG. 9 is a flowchart illustrating an example of the processing operation of the second determination unit 53 related to the second determination process. In FIG. 9, the second determination unit 53 determines whether there is the highest-level candidate path among the candidate paths in the priority memory 42 (Operation S51). When it is determined that there is the highest-level candidate path (“Yes” in Operation S51), the second determination unit 53 designates the candidate path (Operation S52). The second determination unit 53 refers to the wavelength information DB 33 to determine whether or not there is an adjacent available unused candidate wavelength among wavelengths being used on the designated candidate path (Operation S53). Incidentally, an adjacent unused candidate wavelength is, for example, the next-shortest wavelength adjacent to the shortest wavelength.

When it is determined that there is an adjacent available unused candidate wavelength (“Yes” in Operation S53), the second determination unit 53 refers to the mounting information DB 31, the topology information DB 32 and the wavelength information DB 33 to determine whether or not an optical coupler 13 that makes the unused candidate wavelength usable is present in a CD-ROADM 2 (Operation S54). Incidentally, this CD-ROADM 2 is a CD-ROADM 2 which is the start point of traffic. When it is determined that the optical coupler 13 that makes the unused candidate wavelength usable is present in the CD-ROADM 2 (“Yes” in Operation S54), the second determination unit 53 stores the candidate wavelength and the candidate path in the candidate memory 41 (Operation S55).

The second determination unit 53 determines whether or not there is a plurality of candidate wavelengths in the candidate memory 41 (Operation S56). When it is determined that there is a plurality of candidate wavelengths in the candidate memory 41 (“Yes” in Operation S56), the second determination unit 53 determines a shortest candidate wavelength among the plurality of candidate wavelengths as an allocated wavelength and a candidate path corresponding to the shortest candidate wavelength as an allocated path (Operation S57). When it is determined that there is not a plurality of candidate wavelengths in the candidate memory 41 (“No” in Operation S56), the second determination unit 53 proceeds to Operation S57 to determine the shortest candidate wavelength as an allocated wavelength and a candidate path corresponding to the shortest candidate wavelength as an allocated path.

When it is determined that there is no adjacent available unused candidate wavelength among wavelengths being used on the designated candidate path (“No” in Operation S53), the second determination unit 53 determines whether or not there is the next highest-level undesignated candidate path in the priority memory 42 (Operation S58). When it is determined that there is the next highest-level undesignated candidate path (“Yes” in Operation S58), the second determination unit 53 proceeds to Operation S52 to designate the next highest-level undesignated candidate path. When it is determined that there is no highest-level candidate path in the priority memory 42 (“No” in Operation S51), the second determination unit 53 determines that there is no solution of the second determination process (Operation S59), and ends the processing operation illustrated in FIG. 9. When it is determined that there is no next highest-level undesignated candidate path in the priority memory 42 (“No” in Operation S58), the second determination unit 53 proceeds to operation S59 to determine that there is no solution. When it is determined that no optical coupler 13 making the unused candidate wavelength usable is present in the CD-ROADM 2 (“No” in Operation S54), the second determination unit 53 proceeds to Operation S58 to determine whether or not there is the next highest-level undesignated candidate path.

In the second determination unit 53 executing the second determination process, when there is no solution in the first determination unit 52, it is determined whether or not the highest-level candidate path exists in the priority memory 42. When the highest-level candidate path exists in the priority memory 42, the second determination unit 53 determines whether or not there is an adjacent available unused candidate wavelength among the wavelengths being used on the candidate path. When there is an adjacent available unused candidate wavelength, the second determination unit 53 determines whether or not an optical coupler 13 making the unused candidate wavelength usable is present in a CD-ROADM 2. When the optical coupler 13 making the unused candidate wavelength usable is present in the CD-ROADM 2, the second determination unit 53 stores the candidate wavelength and the candidate path in the candidate memory 41. The second determination unit 53 determines the shortest candidate wavelength in the candidate memory 41 as an allocated wavelength and a candidate path corresponding to the shortest candidate wavelength as an allocated path. As a result, the second determination unit 53 can determine the optimal allocated wavelength and allocated path to be used for a new traffic by remote operation. Furthermore, the second determination unit 53 can reduce the chance of irregular wavelength arrangement due to contention avoidance and suppress wavelength fragmentation by reducing the number of wavelengths so as to be arranged continuously to an adjacent wavelength, thereby achieving the high utilization efficiency of wavelength resources.

In the first determination unit 52 of the first embodiment, when there is the shortest wavelength that may be used in the CD-ROADM 2 which as the start point of traffic, the shortest wavelength is set as a candidate wavelength, and it is determined whether or not an optical coupler 13 that can use the candidate wavelength is present in the CD-ROADM 2. When an optical coupler 13 that can use the candidate wavelength is present in the CD-ROADM 2, the first determination unit 52 determines whether or not there is a candidate path in which the candidate wavelength may be used. When there is a candidate path in which the candidate wavelength may be used, the first determination unit 52 stores the candidate wavelength and the candidate path in the candidate memory 41. The first determination unit 52 determines the shortest wavelength candidate wavelength in the candidate memory 41 as an allocated wavelength and a candidate path corresponding to the shortest candidate wavelength as an allocated path. As a result, the first determination unit 52 can determine the optimal allocated wavelength and allocated path to be used for a new traffic by remote operation. Furthermore, the first determination unit 52 can reduce the number of wavelengths to be contended, reduce the chance of irregular wavelength arrangement due to contention avoidance, and suppress wavelength fragmentation, thereby achieving the high utilization efficiency of wavelength resources. Accordingly, the SDN controller 3 can provide the optical transmission system 1 of the CD-ROADM 2 compatible with contention-less and direction-less. Furthermore, it is possible to achieve network operation by the CD-ROADM 2 with low coast and high flexibility.

In the second determination unit 53, when there is no solution in the first determination unit 52, it is determined whether or not the highest-level candidate path exists in the priority memory 42. When the highest-level candidate path exists in the priority memory 42, the second determination unit 53 determines whether or not there is an adjacent available unused candidate wavelength among the wavelengths being used on the candidate path. When there is an adjacent available unused candidate wavelength, the second determination unit 53 determines whether or not an optical coupler 13 making the unused candidate wavelength usable is present in a CD-ROADM 2. When the optical coupler 13 making the unused candidate wavelength usable is present in the CD-ROADM 2, the second determination unit 53 stores the candidate wavelength and the candidate path in the candidate memory 41. The second determination unit 53 determines the shortest candidate wavelength in the candidate memory 41 as an allocated wavelength and a candidate path corresponding to the shortest candidate wavelength as an allocated path. As a result, the second determination unit 53 can determine the optimal allocated wavelength and allocated path to be used for a new traffic by remote operation. Furthermore, the second determination unit 53 can reduce the chance of irregular wavelength arrangement due to contention avoidance and suppress wavelength fragmentation by filling wavelengths so as to be arranged continuously to an adjacent wavelength, thereby achieving the high utilization efficiency of wavelength resources.

It should be noted that the SDN controller 3 of the first embodiment is assumed to be constructed when a plan for laying down line cards is made after traffic demand occurs. However, in the typical operation, the line cards are arranged in advance and allocated paths and allocated wavelengths for traffics are set by remote operation as necessary. Accordingly, the conditions of usable line cards and optical components such as optical couplers 13 and optical splitters 12 physically connected to the line cards are restricted. Another optical transmission system 1 capable of coping with such a situation will be described below as a second embodiment.

### Second Embodiment

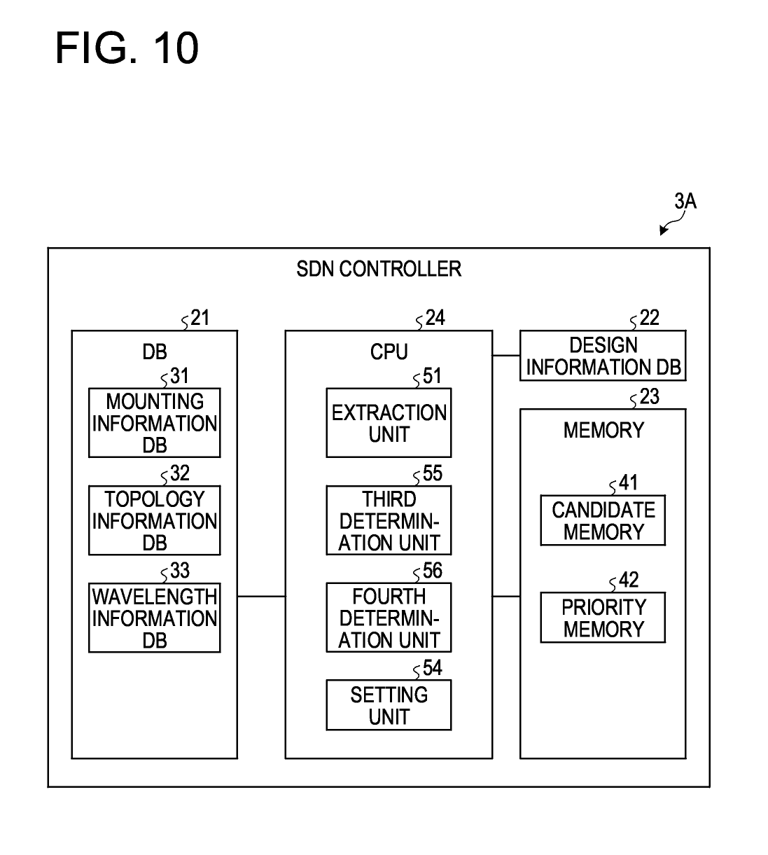

FIG. 10 is an explanatory view illustrating an exemplary functional configuration of a SDN controller 3A according to the second embodiment. In FIG. 10, the same elements and operations as those of the optical transmission system 1 of the first embodiment are denoted by the same reference numerals and therefore, explanation of which will not be repeated. The SDN controller 3A performs the earlier-described first determination process as a third determination process and the earlier-described second determination process as a fourth determination process under the constraint conditions that line cards connected to the same optical coupler 13 (optical splitter 12) in the CD-ROADM 2 excludes a wavelength currently being used.

The CPU 24 includes a third determination unit 55 instead of the first determination unit 52, and a fourth determination unit 56 instead of the second determination unit 53. The third determination unit 55 executes the third determination process. The third determination unit 55 determines whether or not there is the shortest wavelength that may be used by the CD-ROADM 2 serving as a start point of a new traffic. When there is the shortest wavelength that may be used by the CD-ROADM 2 as the start point of the new traffic, the third determination unit 55 determines the shortest wavelength as a candidate wavelength. The third determination unit 55 determines whether or not the same wavelength as the candidate wavelength is being used in an optical coupler 13 in the CD-ROADM 2. When the same wavelength as the candidate wavelength is being used in the optical coupler 13, the third determination unit 55 determines whether or not an available optical coupler 13 whose candidate wavelength is unused exists in the CD-ROADM 2. Incidentally, the CD-ROADM 2 is a CD-ROADM 2 which is the start point of the new traffic. When the available optical coupler 13 whose candidate wavelength is unused exists in the CD-ROADM 2, the third determination unit 55 determines whether there is a candidate path in which the candidate wavelength may be used. When there is a candidate path in which the candidate wavelength may be used, the third determination unit 55 stores the candidate wavelength and the candidate path in the candidate memory 41.

The fourth determination unit 56 executes the fourth determination process. The fourth determination unit 56 determines whether or not the highest-level candidate path exists in the priority memory 42. When the highest-level candidate path exists in the priority memory 42, the fourth determination unit 56 determines whether or not there is an adjacent available unused candidate wavelength among wavelengths being used on the candidate path. When there is an adjacent available unused candidate wavelength, the fourth determination unit 56 determines whether or not the same wavelength as the candidate wavelength is being used by an optical coupler 13 in the CD-ROADM 2. When the same wavelength as the candidate wavelength is being used by the optical coupler 13, the fourth determination unit 56 determines whether or not an optical coupler 13 making the unused candidate wavelength usable is present in the CD-ROADM 2. When the optical coupler 13 making the unused candidate wavelength usable is present in the CD-ROADM 2, the fourth determination unit 56 stores the candidate wavelength and the candidate path in the candidate memory 41.

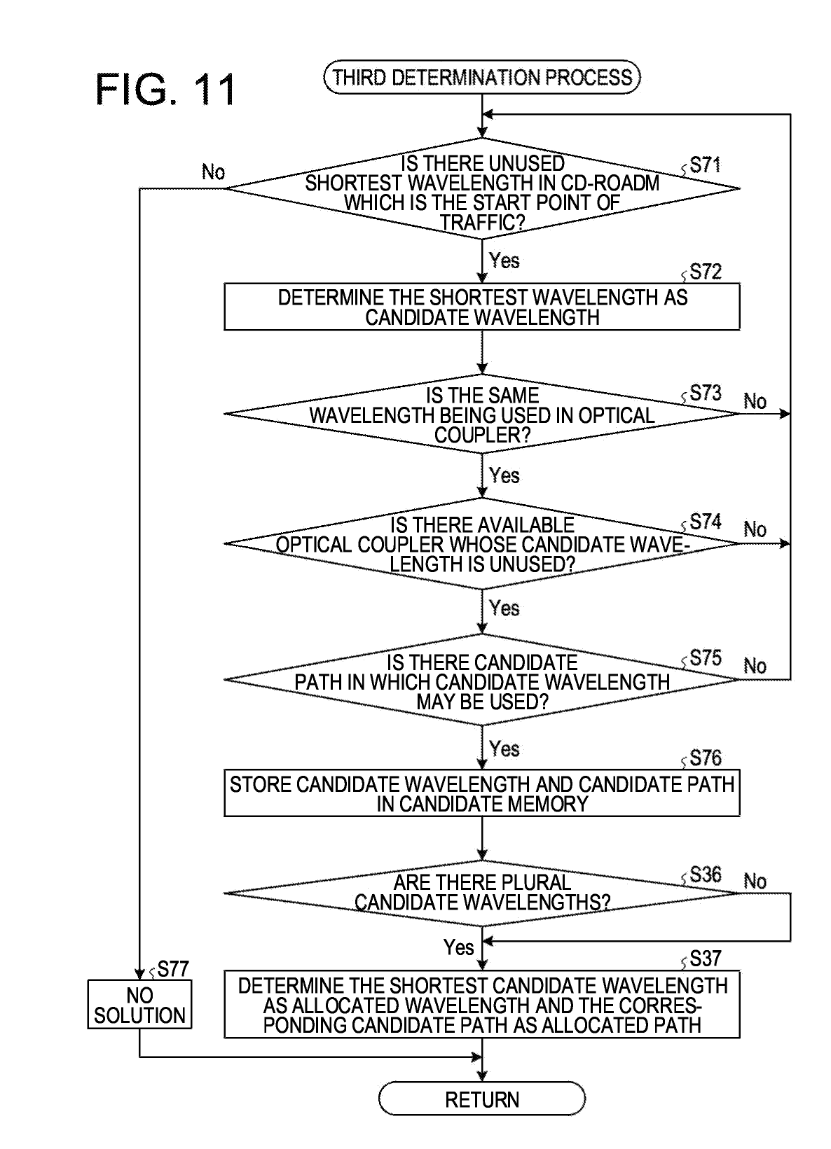

The operation of the optical transmission system 1 of the second embodiment will be described next. FIG. 11 is a flowchart illustrating an example of the processing operation of the third determination unit 55 related to the third determination process. The third determination unit 55 determines whether or not there is an unused shortest wavelength in the CD-ROADM 2 which is the start point of traffic (Operation S71). When it is determined that there is an unused shortest wavelength in the CD-ROADM 2, which is the start point of traffic (“Yes” in Operation S71), the third determination unit 55 determines the shortest wavelength as a candidate wavelength (Operation S72).

Thereafter, the third determination unit 55 determines whether or not the same wavelength as the candidate wavelength is being used in the optical coupler 13 (Operation S73). When it is determined that the same wavelength as the candidate wavelength is being used in the optical coupler 13 (“Yes” in Operation S73), the third determination unit 55 refers to the wavelength information DB 33 and the mounting information DB 31 to determine whether or not an available optical coupler 13 whose candidate wavelength is unused exists in the CD-ROADM 2 (Operation S74).

When it is determined that an available optical coupler 13 whose candidate wavelength is unused exists in the CD-ROADM 2 (“Yes” in Operation S74), the third determination unit 55 determines whether or not there is a candidate path in which the candidate wavelengths may be used (Operation S75). When it is determined that there is a candidate path in which the candidate wavelength may be used (“Yes” in Operation S75), the third determination unit 55 stores the candidate wavelength and the candidate path in the candidate memory 41 (Operation S76) and proceeds to Operation S36 to determine whether or not there is a plurality of candidate wavelengths.

When it is determined that the same wavelength as the candidate wavelength is not being used in the optical coupler 13 (“No” in Operation S73), the third determination unit 55 proceeds to Operation S71 to determine whether or not there is an unused shortest wavelength. When it is determined that no available optical coupler 13 whose candidate wavelength is unused exists in the CD-ROADM 2 (“No” in Operation S74), the third determination unit 55 proceeds to Operation S71 to determine whether or not there is an unused shortest wavelength. When it is determined that there is no candidate path in which the candidate wavelength may be used (“No” in Operation S75), the third determination unit 55 proceeds to Operation S71 to determine whether or not there is an unused shortest wavelength. When it is determined that there is no unused shortest wavelength in the CD-ROADM 2 which is the start point of traffic (“No” in Operation S71), the third determination unit 55 determines that there is no solution of the third determination process (Operation S77), and ends the processing operation illustrated in FIG. 11.

In the third determination unit 55 executing the third determination process illustrated in FIG. 11, when there is the shortest wavelength that may be used in the CD-ROADM 2 which is the start point of traffic, the shortest wavelength is set as a candidate wavelength and it is determined whether or not the same wavelength as the candidate wavelength is being used in the optical coupler 13. When the same wavelength as the candidate wavelength is being used in the optical coupler 13, the third determination unit 55 determines whether or not an optical coupler 13 that can use the candidate wavelength is present in the CD-ROADM 2. When there is an optical coupler 13 that can use the candidate wavelength, the third determination unit 55 determines whether or not there is a candidate path in which the candidate wavelength may be used. When there is a candidate path in which the candidate wavelength may be used, the third determination unit 55 stores the candidate wavelength and the candidate path in the candidate memory 41. The third determination unit 55 determines the shortest candidate wavelength in the candidate memory 41 as an allocated wavelength and a candidate path of the candidate wavelength as an allocated path. As a result, the third determination unit 55 can reduce the number of wavelength to be contended while keeping the allocated path and the allocated wavelength in operation, reduce the chance of irregular wavelength arrangement due to contention avoidance, and reduce wavelength fragmentation, thereby achieving the high utilization efficiency of wavelength resources.

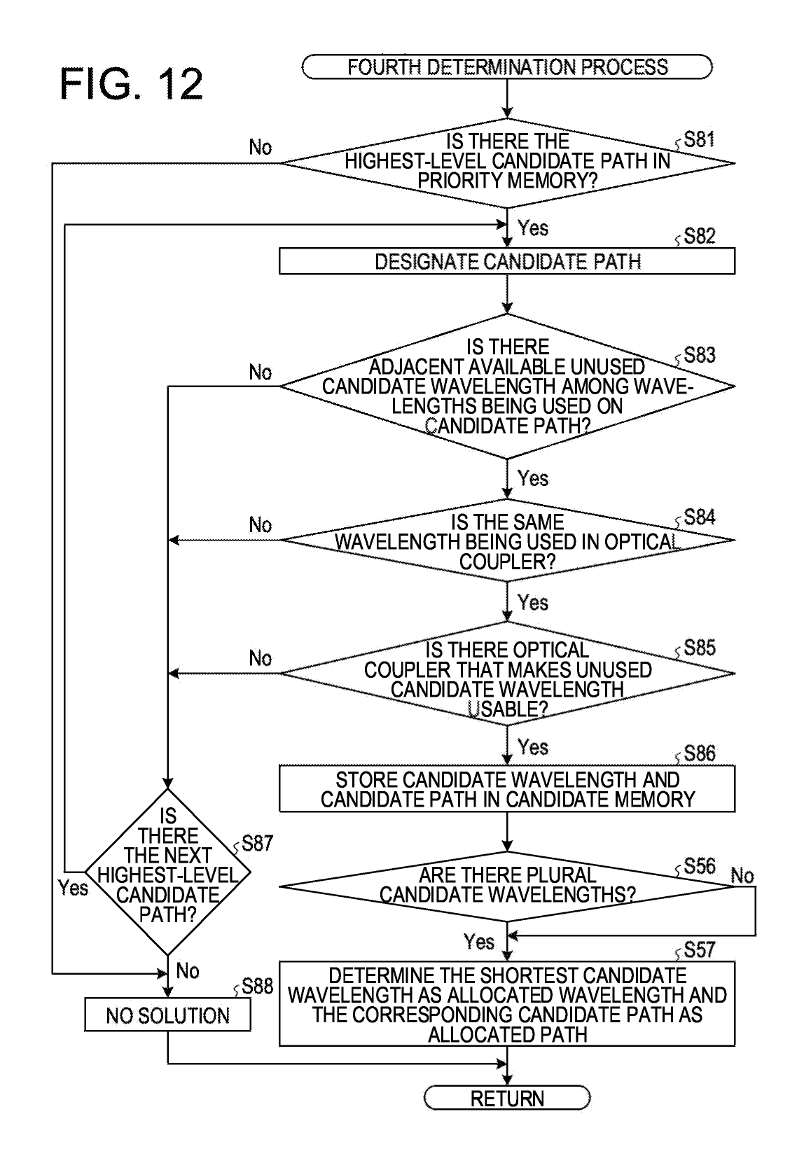

FIG. 12 is a flowchart illustrating an example of the processing operation of the fourth determination unit 56 related to the fourth determination process. The fourth determination unit 56 determines whether or not the highest-level candidate path exists in the priority memory 42 (Operation S81). When it is determined that the highest-level candidate path exists in the priority memory 42 (“Yes” in Operation S81), the fourth determination unit 56 designates the candidate path in the priority memory 42 (Operation S82).

Thereafter, the fourth determination unit 56 determines whether or not there is an adjacent available unused candidate wavelength among wavelengths being used on the highest-level candidate path (Operation S83). Incidentally, an adjacent available unused candidate wavelength is, for example, the next-shortest wavelength adjacent to the shortest wavelength. When it is determined that there is an adjacent available unused candidate wavelength (“Yes” in Operation S83), the fourth determination unit 56 determines whether or not the same wavelength as the candidate wavelength is being used in the optical coupler 13 (Operation S84).

When it is determined that the same wavelength as the candidate wavelength is being used in the optical coupler 13 (“Yes” in Operation S84), the fourth determination unit 56 determines whether or not an optical coupler 13 making the unused candidate wavelength usable exists in the CD-ROADM 2 (Operation S85). When it is determined that an optical coupler 13 making the unused candidate wavelength usable exists in the CD-ROADM 2 (“Yes” in Operation S85), the fourth determination unit 56 stores the candidate wavelength and the candidate path in the candidate memory 41 (Operation S86) , and proceeds to Operation S56.

When it is determined that there is no adjacent available unused candidate wavelength among wavelengths being used on the candidate path (“No” in Operation S83), the fourth determination unit 56 determines whether or not there is the next highest-level undesignated candidate path in the priority memory 42 (Operation S87). When it is determined that there is the next highest-level undesignated candidate path (“Yes” in Operation S87), the fourth determination unit 56 proceeds to Operation S82 to designate the next highest-level undesignated candidate path.

When it is determined that there is no highest-level candidate path in the priority memory 42 (“No” in Operation S81), the fourth determination unit 56 determines that there is no solution of the fourth determination process (Operation S88), and ends the processing operation illustrated in FIG. 12. When it is determined that there is no next highest-level undesignated candidate path (“No” in Operation S87), the fourth determination unit 56 proceeds to Operation S88 to determine that there is no solution of the fourth determination process. When it is determined that the same wavelength as the candidate wavelength is not being used in the optical coupler 13 (“No” in Operation S84), the fourth determination unit 56 proceeds to Operation S87 to determine whether or not there is the next highest-level undesignated candidate path. When the optical coupler 13 making the unused candidate wavelength usable does not exist in the CD-ROADM 2 (“No” in Operation S85), the fourth determination unit 56 proceeds to Operation S87 to determine whether or not there is the next highest-level undesignated candidate path.

In the fourth determination unit 56 executing the fourth determination process, when there is no solution in the third determination unit 55, it is determined whether or not the highest-level candidate path exists in the priority memory 42. When there is the highest-level candidate path in the priority memory 42, the fourth determination unit 56 determines whether or not there is an adjacent available unused candidate wavelength among the wavelengths being used on the highest-level candidate path. When there is an adjacent available unused candidate wavelength, the fourth determination unit 56 determines whether or not the same wavelength as the candidate wavelength is being used in the optical coupler 13. When the same wavelength as the candidate wavelength is being used in the optical coupler 13, the fourth determination unit 56 determines whether or not an optical coupler 13 making the unused candidate wavelength usable is present in the CD-ROADM 2. When an optical coupler 13 making the unused candidate wavelength usable is present in the CD-ROADM 2, the fourth determination unit 56 stores the candidate wavelengths and the candidate paths in the candidate memory 41. The fourth determination unit 56 determines the shortest candidate wavelength in the candidate memory 41 as an allocated wavelength and a candidate path corresponding to the shortest candidate wavelength as an allocated path. As a result, the fourth determination unit 56 can reduce the chance of irregular wavelength arrangement due to contention avoidance while keeping the allocated path and the allocated wavelength in operation and suppress wavelength fragmentation by filling wavelengths so as to be arranged continuously to an adjacent wavelength, thereby achieving the high utilization efficiency of wavelength resources.

The SDN controller 3A according to the second embodiment can reduce the chance of irregular wavelength arrangement due to contention avoidance while keeping the allocated path and the allocated wavelength in operation and suppress wavelength fragmentation by filling wavelengths so as to be arranged continuously to an adjacent wavelength, thereby achieving the high utilization efficiency of wavelength resources.

In Operation S36 illustrated in FIGS. 8 and 11 and Operation S56 illustrated in FIGS. 9 and 12, when there is a plurality of candidate wavelengths in the candidate memory 41, the shortest candidate wavelength is determined as an allocated wavelength and a candidate path corresponding to the shortest candidate wavelength is determined as an allocated path. However, the present disclosure is not limited thereto. Instead of the candidate wavelengths, when there is a plurality of candidate paths in the candidate memory 41, for example, a candidate path having the shortest transmission distance may be determined as an allocated path and a candidate wavelength corresponding to the candidate path may be determined as an allocated wavelength.

In Operation S37 illustrated in FIGS. 8 and 11 and Operation S57 illustrated in FIGS. 9 and 12, the shortest candidate wavelength is set as the allocated wavelength. However, the longest candidate wavelength may be set as the allocated wavelength and a candidate wavelength with high utilization rate may be used as the allocated wavelength. As another example, it has been described that the candidate path having the shortest transmission distance may be used as an allocated path, but the present disclosure is not limited thereto. For example, a path with the minimum cost, the minimum number of spans, the minimum number of nodes or high utilization rate may be used as the allocated path and may be appropriately changed.

In Operation S31 illustrated in FIG. 8, it is determined whether or not there is the shortest wavelength that may be used in the CD-ROADM 2 serving as the start point of traffic. However, the present disclosure is not limited thereto. For example, it may be determined whether or not there is the shortest wavelength that may be used in a CD-ROADM 2 serving as the end point of traffic instead of the start point of traffic. When it is determined whether or not there is the shortest wavelength that may be used in the CD-ROADM 2 serving as the end point of traffic, it is determined in Operation S33 whether or not an optical splitter 12, instead of the available optical coupler 13 whose candidate wavelength is unused, is present in the CD-ROADM 2. In addition, in Operation S54 illustrated in FIG. 9, it is determined whether or not an optical splitter 12, instead of the optical coupler 13 making the unused candidate wavelength usable, is present in the CD-ROADM 2.

In Operation S53 illustrated in FIG. 9, it is determined whether or not there is an adjacent available unused candidate wavelength among wavelengths being used on the highest-level candidate path specified in the priority memory 42 in Operation S52. However, present disclosure is not limited thereto. When it is determined that another optical coupler 13 that does not use a wavelength being used in the first determination unit 52A does not exist in the CD-ROADM 2, the third determination unit 53A designates a wavelength adjacent to the wavelength in use. Then, the third determination unit 53A may determine whether or not there is a path making the designated adjacent wavelength usable.

In Operation S71 illustrated in FIG. 11, it is determined whether or not there is the shortest wavelength that may be used in the CD-ROADM 2 serving as the start point of traffic. However, the present disclosure is not limited thereto. For example, it may be determined whether or not there is the shortest wavelength that may be used in a CD-ROADM 2 serving as the end point of traffic instead of the start point of traffic. When it is determined whether or not there is the shortest wavelength that may be used in the CD-ROADM 2 which is the end point of traffic, the optical coupler 13 is replaced with an optical splitter 12 in Operations S73 and S74. Further, the optical coupler 13 is also arranged with an optical splitter 12 in Operations S84 and S85.

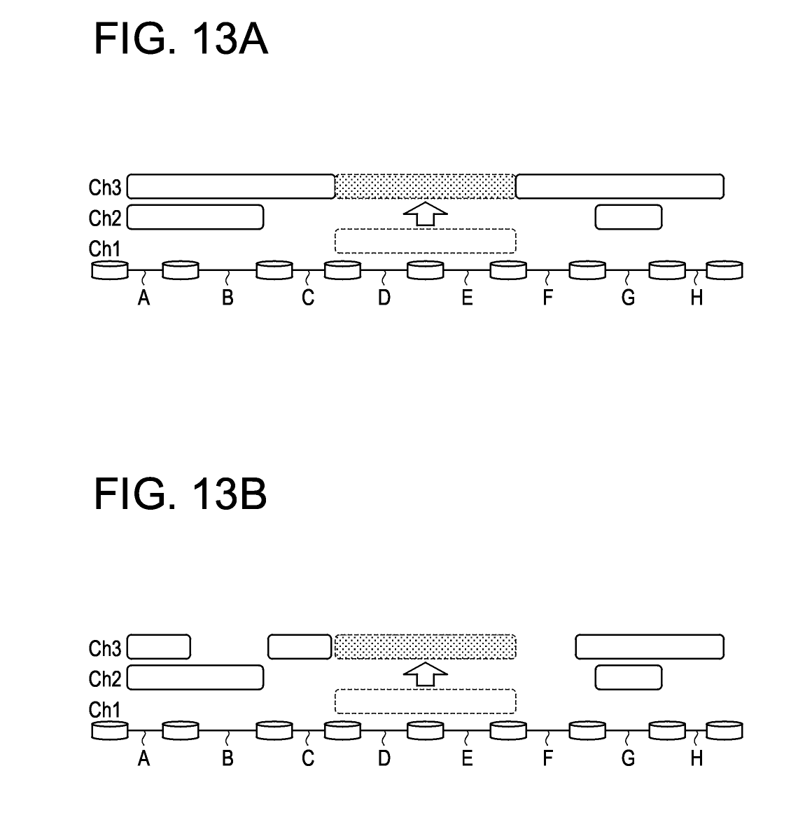

In the first and second embodiments, wavelengths are filled and arranged from the shortest wavelength in order to suppress wavelength fragmentation. However, the present disclosure is not limited thereto. For example, wavelengths may be preferentially filled from a wavelength with high utilization rate in the optical transmission system 1 and may be changed as appropriate. FIGS. 13A and 13B are explanatory views illustrating an example of a wavelength allocation method of an optical transmission system 1 according to another embodiment.

In the optical transmission system 1 of the wavelength allocation method of FIG. 13A, it is assumed that spans A to H are provided and wavelengths Ch1, Ch2 and Ch3 are being used in the spans D and E, the spans A, B and G and the spans A to C and F to H, respectively. The SDN controller 3 has the highest utilization rate of the wavelength Ch3 and the lowest utilization rate of the wavelength Ch1. The SDN controller 3 changes the wavelength Ch1 of the spans D and E to the wavelength Ch3. As a result, wavelength fragmentation may be suppressed by filling wavelengths continuously to a wavelength with high utilization rate, thereby achieving the high utilization efficiency of wavelength resources.

In the optical transmission system 1 of the wavelength allocation method of FIG. 13B, it is assumed that wavelengths Ch1, Ch2 and Ch3 are being used in the spans D and E, the spans A, B and G and the spans A, C, G and H, respectively. It is assumed that the utilization rate of the wavelength Ch3 is the highest and the utilization rate of the wavelength Ch1 is the lowest. The SDN controller 3 changes the wavelength Ch1 of the spans D and E to the wavelength Ch3. As a result, even when wavelengths with high utilization rate are not continuously buried, wavelength fragmentation may be suppressed by filling wavelengths continuously to the wavelengths with high utilization rate, thereby achieving the high utilization efficiency of wavelength resources.

Although it is not difficult for the SDN controller 3 (3A) to monitor the use situations of the wavelengths of all the paths in the optical transmission system 1, it is burdensome to monitor the utilization rate of wavelengths in a wide range of paths within the optical transmission system 1. Therefore, the SDN controller 3 (3A) may specify an arbitrary monitoring target range in the optical transmission system 1 according to a designated operation, monitor the utilization rate of wavelengths of the respective paths within the monitoring target range, and collect a wavelength with the highest utilization rate among these.

In the above embodiments, the SDN controller 3 (3A) for managing the CD-ROADMs 2 in the optical transmission system 1 has been exemplified. However, for example, these embodiments may be applied to an NMS (Network Management System) and may be changed as appropriate. The SDN controller 3 (3A), for example, is a management device. The optical transmission system 1 is not limited to a mesh configuration but may be applied to, for example, a star type, a linear type or a tour type and may be changed as appropriate.

In addition, constituent elements of the various depicted parts are not necessarily physically configured as illustrated in the drawings. In other words, the specific forms of distribution and integration of the various parts are not limited to those illustrated in the drawings, but all or some thereof may be distributed or integrated functionally or physically in arbitrary units depending on various loads and use situations.

Furthermore, the various processing functions performed by the respective devices may be entirely or partially executed on a CPU (Central Processing Unit) (or a microcomputer such as an MPU (Micro Processing Unit) or an MCU (Micro Controller Unit)). Further, the various processing functions may be entirely or partially executed on a program that is analyzed and executed by a CPU (or a microcomputer such as an MPU or an MCU) or on hardware using a wired logic.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

hat is claimed is:

1. A management device configured to manage a plurality of optical nodes in an optical transmission system, the management device comprising:
a memory; and
a processor coupled to the memory and the processor configured to:
specify an optical node to terminate a traffic in the optical transmission system;
determine whether or not a first optical component that does not use a wavelength being used in a second optical component included in the specified optical node exists in the specified optical node;
determine whether or not a path that makes the wavelength usable exists in the optical transmission system when it is determined that the first optical component exists in the specified optical node; and
set the wavelength and the path that makes the wavelength usable in the first optical component when it is determined that the path making the wavelength usable exists in the specified optical node.

2. The management device according to claim 1,
wherein the processor is further configured to:
when it is determined that the first optical component does not exist in the specified optical node,
designate an adjacent wavelength adjacent to the wavelength; and
determine whether or not a path that makes the designated adjacent wavelength usable exists in the optical transmission system, and
when it is determined that the path that makes the designated adjacent wavelength usable exists,
set the designated adjacent wavelength and the path that makes the designated adjacent wavelength usable in the first optical component used for the traffic.

3. The management device according to claim 1,
wherein the processor is further configured to:
designate a wavelength being used in the second optical component included in the specified optical node according to a first priority; and
determine whether or not the first optical component that does not use the designated wavelength exists in the specified optical node.

4. The management device according to claim 3,
wherein the first priority is defined based on a length of the wavelength among wavelengths used in the optical transmission system.

5. The management device according to claim 3,
wherein the first priority is defined based on an utilization rate of each of wavelengths used in the optical transmission system.

6. The management device according to claim 2,
wherein the processor is further configured to:
when it is determined that the first optical component does not exist in the specified optical node,
designate a path according to a second priority; and
designate the adjacent wavelength adjacent to the wavelength being used in the designated path.

7. The management device according to claim 6,
wherein the second priority is defined based on a length of transmission distance of a path among paths used in the optical transmission system.

8. A wavelength setting method executed by a processor included in a management device configured to manage a plurality of optical nodes in an optical transmission system, the wavelength setting method comprising:
specifying an optical node to terminate a traffic in the optical transmission system;
determining whether or not a first optical component that does not use a wavelength being used in a second optical component included in the specified optical node exists in the specified optical node;
determining whether or not a path that makes the wavelength usable exists in the optical transmission system when it is determined that the first optical component exists in the specified optical node; and
setting the wavelength and the path that makes the wavelength usable in the first optical component when it is determined that the path making the wavelength usable exists in the specified optical node.
